(19) United States
(12) Patent Application Publication
(10) Pub. No.: US 2010/0115556 A1
(43) Pub. Date: May 6, 2010

(54) METHOD AND APPARATUS FOR DISPLAYING VIDEO CLIPS

(76) Inventors: Henry C. Yuen, Pasadena, CA (US); Roy J. Mankovitz, Montecito, CA (US); Daniel S. Kwoh, La Canada, CA (US); Elise Y. Leung, La Canada, CA (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 12/551,392

(22) Filed: Aug. 31, 2009

Related U.S. Application Data
(63) Continuation of application No. 10/753,090, filed on Jan. 6, 2004, now abandoned.
Application No. 10/753,090 is a continuation of application No. 09/069,065, filed on Apr. 28, 1998, now abandoned.
Application No. 09/069,065 is a continuation of application No. 08/715,782, filed on Sep. 19, 1996, now abandoned.
Application No. 08/715,782 is a continuation-in-part of application No. 08/475,395, filed on Jun. 7, 1995, now Pat. No. 6,239,794.
Application No. 08/475,395 is a continuation-in-part of application No. 08/424,863, filed on Apr. 17, 1995, now abandoned.
Application No. 08/424,863 is a continuation-in-part of application No. 08/369,522, filed on Jan. 5, 1995, now abandoned.
Application No. 08/369,522 is a continuation-in-part of application No. 08/312,863, filed on Sep. 27, 1994, now abandoned.
Application No. 08/312,863 is a continuation-in-part of application No. 08/298,997, filed on Aug. 31, 1994, now abandoned.
Application No. 09/069,065 is a continuation-in-part of application No. 08/066,666, filed on May 27, 1993, now abandoned.

(51) Int. Cl. H04N 5/445

(52) U.S. Cl. 725/41; 725/52

(57) ABSTRACT

A television viewer uses a PIP format for display of program related information such as television program listings from a program schedule data base in the background and moving, real time or stored video clip images of a program selected from the displayed listings in the PIP window. All the text of the background information lies outside the PIP window. In one embodiment, as the viewer selects a particular program from the display of current television program listings by means of a cursor or a code number, the corresponding program automatically appears in the PIP window.

### CROSS-REFERENCE TO RELATED APPLICATIONS

This application is a continuation of application Ser. No. 08/715,782, filed Sep. 19, 1996, which is a continuation-in-part of application Ser. No. 08/475,395, filed Jun. 7, 1995, which is a continuation-in-part of application Ser. No. 08/424,863, filed Apr. 17, 1995, now abandoned, which is a continuation-in-part of application Ser. No. 08/369,522, filed Jan. 5, 1995, now abandoned, which is a continuation-in-part of application Ser. No. 08/312,863, filed Sep. 27, 1994, now abandoned, which is a continuation-in-part of application Ser. No. 08/298,997, filed Aug. 31, 1994, now abandoned. This application is also a continuation-in-part of application Ser. No. 08/066,666, filed May 27, 1993. The disclosures of these applications are incorporated fully herein by reference.

### BACKGROUND OF THE INVENTION

This invention relates to the field of television and, more particularly, to a method and apparatus for simultaneously displaying video programs and related text on a television screen.

For a number of years television receivers have been equipped with picture-in-picture (PIP) capability. In PIP format, the moving, real time images of one television channel are displayed on the background of the screen and the moving, real time images of another television channel are displayed in a PIP window overlaid on a small area of the background. Because two channels are simultaneously displayed by the television receiver, two tuners are required. The viewer enters the PIP mode by pressing a PIP key of his or her controller. Then, the viewer can change either the channel of the background or the channel of the PIP by resetting the appropriate tuner. To reverse the background and PIP images, the viewer simply presses a SWAP key. To collapse the PIP window, the viewer again presses the PIP key.

Television program guides help television viewers select programs to watch. Such television program guides list the available television programs by day of the week, time of day, channel, and program title. For many years television program guides have been published in hard copy form. More recently as illustrated by Levine U.S. Pat. No. 4,908,713, television program guides have begun to take an electronic form. In other words, the schedule of program listings is stored in an electronic memory connected to the television receiver. The program listings are recalled from memory by the viewer on command for display on the television screen.

Despite the prevalence of television program guides, many viewers still make their program selections by switching the television tuner from channel to channel and observing on the screen what program is being received on the respective channels. This process is sometimes called “surfing”.

Emanuel U.S. Pat. No. 5,161,019 discloses an automated form of channel surfing. A preselected group of channels are sequentially scanned by switching the tuner of the television receiver from channel to channel. A still image of the program received on each channel is stored in a memory. After all the channels have been scanned, the still images from all the channels are simultaneously displayed on the television screen. This process gives the viewer more information about the program choices in addition to that obtainable from a television program guide, namely, the displayed still images of the actual programs.

### SUMMARY OF THE INVENTION

According to the invention, the moving images of a video clip or preview of a future television program are displayed in a PIP window on the screen of a television monitor and future television program listings from a program schedule data base are displayed in the background on the screen. Preferably, the audio portion of the television program displayed in the PIP window is also reproduced by the sound system of the television monitor. The textual information is arranged on the screen so none of it is covered by the moving images. When a future program listing on the screen is marked with a cursor, the corresponding video clip is retrieved and displayed in the PIP window. If the user wishes to receive the telecast program previewed by the video clip, a command is issued to retrieve the time and channel of the program from the data base and to set the television tuner to the channel and time that the program is telecast. If desired, the transaction could be recorded for billing purposes.

### BRIEF DESCRIPTION OF THE DRAWINGS

The features of specific embodiments of the best mode contemplated of carrying out the invention are illustrated in the drawings, in which:

FIG. 1 is a schematic block diagram of a television receiver that has an electronic television program guide incorporating the principles of the invention;

FIGS. 2 to 4 are television screens formatted in accordance with the embodiment of FIG. 1; and

FIG. 5 is a top plan view of a remote controller for operating the electronic program guide of FIG. 1.

### DETAILED DESCRIPTION OF A SPECIFIC EMBODIMENT

In a preferred embodiment, the invention displays information about television program schedules and content in a tripartite electronic television program guide. One screen format is a time specific program guide (TISPG); another screen format is a channel specific program guide (CSPG); and the third screen format is a theme specific program guide (THSPG). In each case, video clips of television program to be telecast in the future are displayed in real time in a PIP window.

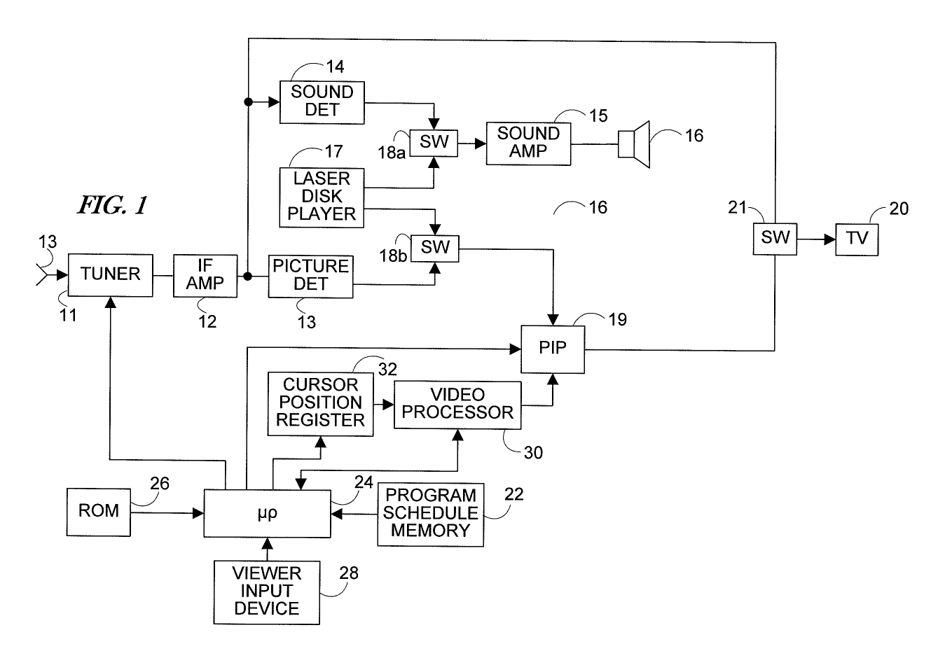

With reference to FIG. 1, a source of television signals 10 such as a terrestrial antenna or a cable drop is connected to a television tuner 11. The output of tuner 11 is a modulated intermediate frequency signal containing video and audio television information. Tuner 11 is connected by an intermediate frequency amplifier (IF AMP) 12 to a picture detector (PICTURE DET) 13 and a sound detector (SOUND DET) 14, which produce base band video and audio signals, respectively, and to one input of a switch 21. Video clips relating to future telecast programs are stored in a laser disk player 17. SOUND DET 14 is connected to one input of a switch 18a. The audio output of disk player 17 is connected to the other input of switch 18a. PICTURE DET 14 is connected to one input of a switch 18b. The video output of disk player 17 is connected to the other input of switch 18b. The audio signal at the output of switch 18a is coupled by a sound amplifier (SOUND AMP) 15 to a loudspeaker 16. The video signal at the output of switch 18b is coupled by a video amplifier not shown to one input of a conventional picture-in-picture (PIP) integrated circuit chip 19. Sound detector 14 and picture detector 13 could also be connected to the audio and video inputs, respectively, of a video cassette recorder, not shown, to enable the viewer to record telecast programs. The output of PIP chip 19 is connected to one input of a switch 21.

IF AMP 12 is connected to the other input of switch 21. The output of switch 21 is coupled to the video and audio inputs of a television receiver or monitor (TV) 20 having a screen (not shown). Loudspeaker 16 could be part of TV 20.

An updatable data base of the schedule of program listings of all the available channels for a prescribed period of time, e.g. a day or a week, is electronically stored in a program schedule memory 22. These program listings typically include for each program the title, a program description, the day of the week, the start time of the day, the program length, and the channel on which the program is transmitted and thus available for reception at source 10. In a preferred embodiment of the invention, the period of time for which the program listings are stored is different for the guides, depending upon viewer priorities and preferences. For example, the information needed to display the TISPG and CSPG may be stored for one or two days and the information needed to display the TSPG may be stored for a week or more. The data base can be updated by a continuous data link in the vertical blanking interval (VBI) of one television channel telecast to the television receiver in well known fashion. Alternatively, the data base can be updated by unplugging memory 22 and replacing it with a memory having the updated data base. Memory 22 is connected to a microprocessor 24 that is programmed to control the operation of the described equipment. An operating program for microprocessor 24 is stored in a read only memory (ROM) 26. A viewer input device 28, preferably in the form of a remote IR controller, is coupled to microprocessor 24 to provide commands from the viewer. A video processor 30 is coupled to microprocessor 24. When the viewer wishes to see television program listings, microprocessor 24 recalls a portion of the program schedule data base from memory 22 and couples it to video processor 30, where the program listings are formatted for display. Preferably, the information stored in video processor 30 is a bit map of what is displayed on the screen of television receiver 20. Video processor 30 is connected to the other input of PIP chip 19. Preferably, viewer input device 28 controls microprocessor 24 by cursor movement on the screen of television receiver 20. To this end, microprocessor 24 and video processor 30 are coupled to a cursor position register 32. (Alternatively, the viewer can select items of information displayed on the screen by keying into viewer input device 28 code numbers assigned to these items.) Microprocessor 24 is also coupled to tuner 11 for channel change, to disk player 17 for play/record selection and start/stop, to switch 18 for selection of one of its inputs, and to PIP chip 19 for selection of the mode of PIP operation.

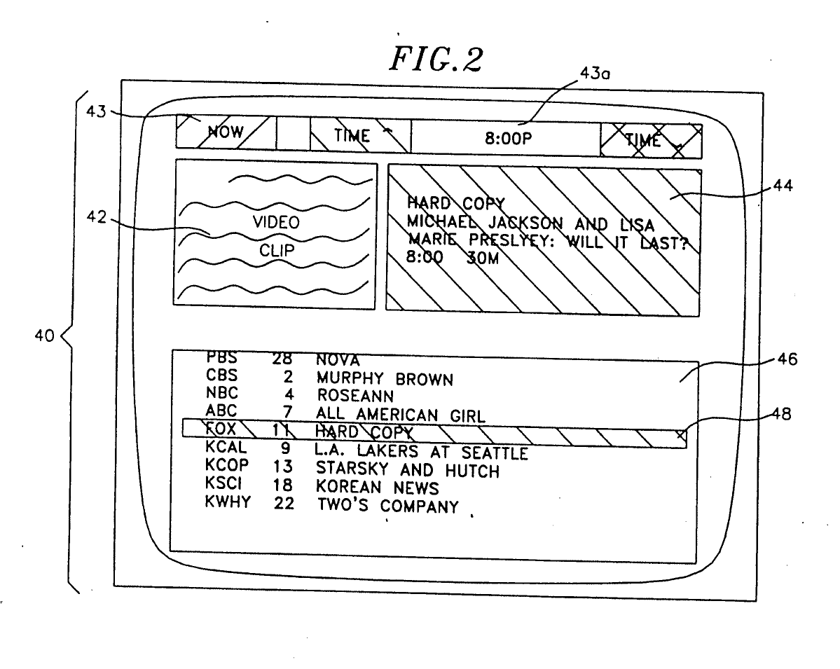

The formats of the electronic program guide are shown in FIGS. 2 to 4. Each format has a background area 40 and an overlaid PIP window 42 in the upper left-hand corner of the screen. The real time, i.e., 6:15 p.m., is displayed in a sub-area 42a PIP window 42. Background area 40 includes a banner and message prompting area 43 at the top of the screen, a program description area 44 in the upper right-hand corner of the screen adjacent to PIP window 42, and a program schedule area 46 below areas 42 and 44. Program description area 44 includes the start time and length (duration) of the program being described. The viewer can move a cursor 48 vertically to highlight one of the program listings displayed in area 46. The highlighted background of cursor 48 and the background of program description area 44 are the same color or shade. In each format, video clips or previews of a television program to be telecast in the future are displayed in PIP window 42 in the form of complete, moving images and the audio portion of the television program displayed in PIP window 42 is reproduced by the sound system of monitor 20. The information displayed in areas 43, 44, and 46 varies depending upon the format, but in each case it relates to the television programs to be telecast in the future.

One version of the TISPG screen format is shown in FIG. 2, namely a version that displays program listings of television programs being telecast at a future time. In the following description, this format is sometimes called the “NEXT” guide. The viewer can select the future time of the program listings to be displayed at intervals such as one-half hour. The selected future time, i.e., 8:00 p.m., for the program listings displayed in area 46 is shown in a sub-area 43a of area 43. A brief program description of the program listing highlighted in area 46 by cursor 48 is displayed in area 44. A video clip of a program to be telecast in the future, namely the program represented by the program listing highlighted by cursor 48, is displayed in PIP window 42.

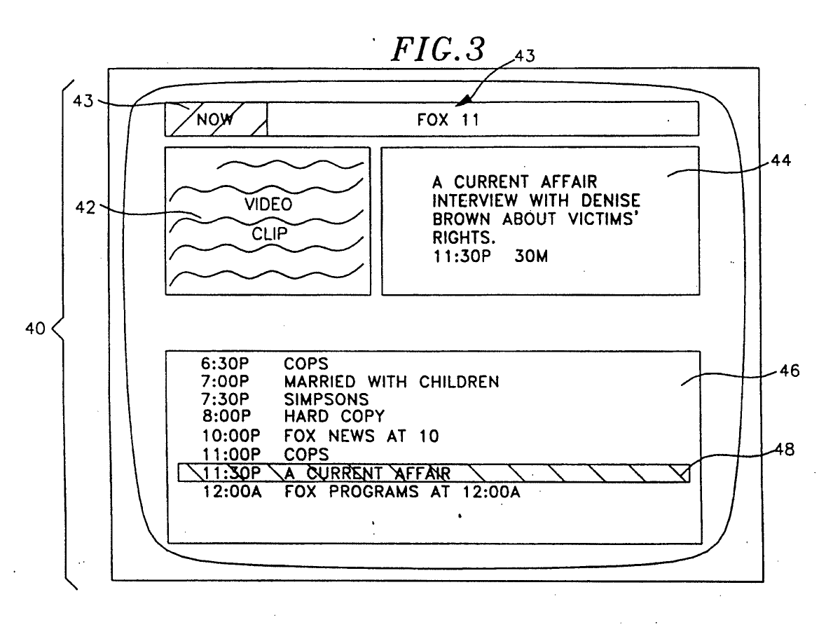

In FIG. 3, the CSPG screen format is shown. In the following description, this format is sometimes called the “THIS CHANNEL” guide. All the program listings for a selected channel, i.e., FOX Channel 7 or a pay-per-view (PPV) channel, are displayed in area 46, from the currently telecast program into the future for a specified time period, e.g., 24 hours or until the end of the next day. Area 46 has a column for time and a column for program title; each line of area 46 represents a separate program listing. A video clip of a program to be telecast in the future is displayed in PIP window 42, namely the program represented by the program listing highlighted by cursor 48. A brief program description of the highlighted program is displayed in area 44.

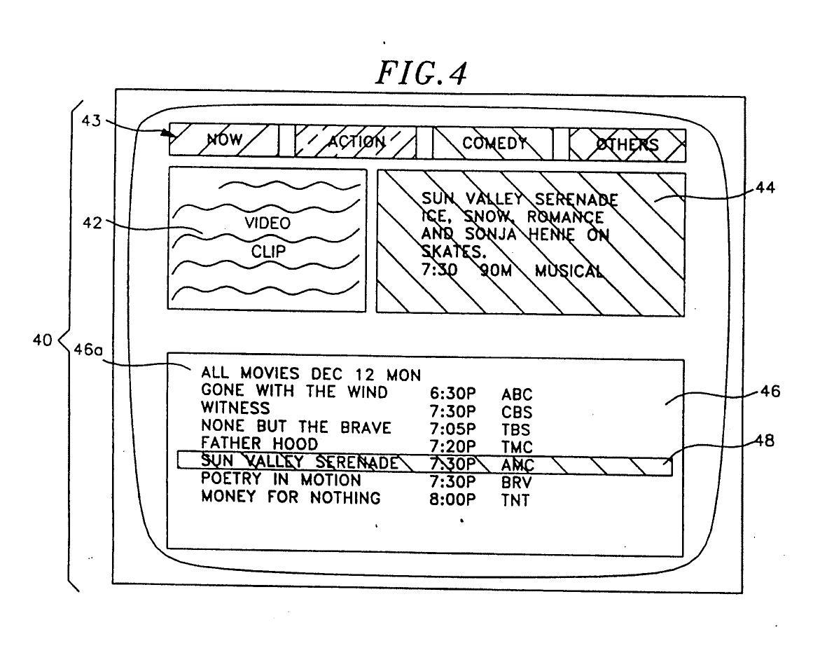

In FIG. 4, the THSPG screen format is shown. In the following description, this format is sometimes called the “SORT” guide. The program listings for a selected theme or subtheme, i.e., ALL MOVIES, are displayed in area 46, from the next telecast program into the future for a specified time period, e.g., one week. Area 46 has a heading 46a that identifies the theme or subtheme, date, and day, i.e., ALL MOVIES DEC 12 MON, a column for title, a column for start time, and a column for channel name or number; each line of area 46 represents a separate program listing. A video clip of a program to be telecast in the future is displayed in PIP window 42, namely the program represented by the program listing highlighted by cursor 48. A brief program description of the program highlighted by cursor 48 is displayed in area 44.

All four areas of background 40 are formatted in video processor 30. The memory space of video processor 30 corresponding to the area in which PIP window 42 appears on the screen is left blank; i.e., although overlaid on background area 40, PIP window 42 does not cover up any of the information of background area 40. By means of a pair of up/down arrows on viewer input device 28, the viewer can move a cursor 48 vertically to highlight the listing of one of the television programs displayed in area 46. Preferably, to reduce delays in displaying the program schedules, all the program listings for the particular screen format are stored in video processor 30, even though only a fraction of them are displayed at the same time. When the cursor reaches the top or bottom listing in area 46, microprocessor 24 recalls further program listings from video processor 30 for display on the screen of television receiver 20.

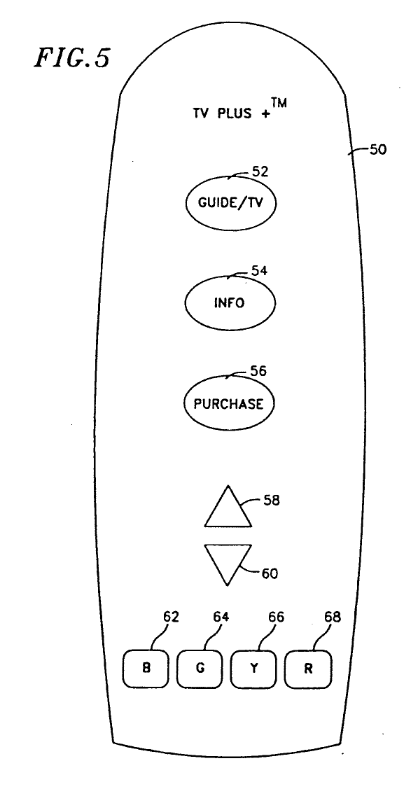

In all the formats, the video clips of the future television program highlighted by cursor 48 are displayed in PIP window 42, the program description of the highlighted program is displayed in area 44, program listings of one type or another are displayed in area 46, and one or more prompts are displayed in banner area 43. The audio portion of the television program displayed in PIP window 42 is reproduced by the sound system of monitor 20. The PIP display, the sound reproduction, and the program description in area 44 enable the viewer to assess better whether or not to watch the highlighted program. Reference is made to FIG. 5 for a further description of the operation of the described system. Viewer input device 28 preferably takes the form of a hand-held remote infrared (IR) transmitter which communicates with an infrared receiver connected to microprocessor 24. The IR transmitter has a housing 50 on which a number of control buttons are mounted. A GUIDE/TV button 52, an INFO button 54, and a PURCHASE button 56 are located above up and down arrow buttons 58 and 60. A row of buttons 62, 64, 66 and 68 which marked with the colors red (R), green (G), yellow (Y), and blue (B), respectively, underlie down arrow button 60. Red, green, yellow, and blue prompts are displayed in area 43 of the electronic guides. To select a prompt on the screen, the button of the IR transmitter having the corresponding color is pressed, i.e., to select the blue prompt on the screen, blue button 68 is pressed.

As the viewer moves cursor 48 vertically from program listing to program listing by operating up/down arrow buttons 58, 60, the video clip displayed in window 42 and the program description displayed in area 44 automatically change accordingly to match the highlighted program in area 46. As the cursor moves from one program listing to another, the address of the video clip of the highlighted program listing is recalled from the data base in memory 22, the video clip is retrieved from VCR 17 at the recalled address and displayed in PIP window 42, microprocessor 24 recalls the program description for the highlighted listing from program schedule memory 22, and video processor 30 formats this program description so it can be displayed in area 44.

Preferably, two levels of detail are available for the program description. Normally, the first level detail of the program description is displayed in area 44 as described above. When more detail is desired, the viewer operates input device 28 to display a second level detail of the program description. Specifically, the viewer presses INFO button 54. There are two options for the display of the second level detail. As one option, the second level detail can replace the first level detail in area 44. This has the advantage that the program listings can continue to be seen by the viewer while more detail about the program description is displayed. As the other option, the second level detail can replace the program listings in area 46. This has the advantage that more space is available to display the second level of detail than the first level.

The invention can be used to great advantage to deliver PPV programs to television viewers. The video clips can be stored in disk player 17 at the television receiver. In such case, switches 18a and 18b connect disk player 17 to SOUND AMP 15 and PIP chip 19. Alternatively, the video clips can be stored at the head end of a cable network that feeds the telecast video programs to tuner 11. In this case, switches 18a and 18b connect SOUND DET 14 to SOUND AMP 15 and PICTURE DET 13 to PIP chip 19. When the viewer highlights a program listing with the cursor, the channel number on which the video clip is being transmitted from the head end is recalled from the data base in memory 22 and the video clip is displayed in the PIP window. If the viewer decides to order the program represented by the video clip, the viewer presses the PURCHASE button. As a result, a command is issued by microprocessor 24 to retrieve the time and channel of such program from the data base and to set tuner 11 to the channel and at the future time that the program is telecast. The program can be viewed in real time and/or time shifted by recording on a VCR. The transaction is then recorded for billing purposes.

In the described guide mode, switch 21 transmits the output of PIP chip 19 to TV 20, instead of the output of IF AMP 12. In the TV mode, switch 21 transmits the output of IF AMP 12 to TV 20, instead of the output of PIP chip 19. The viewer can toggle back and forth between the guide and TV modes by repeatedly pressing GUIDE/TV button 52.

The need for scrambling PPV programs may be lessened or eliminated by the invention. Specifically, manual access to the PPV channels could be blocked, so the only way to set tuner 11 to a PPV channel is to select the program listing from the guide of FIGS. 2 to 4, as described in the preceding paragraph.

The described embodiments of the invention are only considered to be preferred and illustrative of the inventive concept; the scope of the invention is not to be restricted to such embodiment. Various and numerous other arrangements may be devised by one skilled in the art without departing from the spirit and scope of this invention. For example, the disclosed electronic guide features, including the techniques for navigating through the guide, can be used without displaying a real time image of a current television program.

1. (canceled)

2. A system for displaying a video clip for a television program upon viewer selection of a corresponding television program listing from a television program guide displayed on a display screen, comprising:
means for storing video clips, wherein the video clips include moving images of a program that is scheduled for future broadcast;
means for associating the stored video clips with television program listings;
means for displaying the television program guide on the display screen, wherein the television program guide comprises some of the television program listings;
means for allowing a viewer to select one of the television program listings from the television program guide, the selected television program listing corresponding to a respective program that is scheduled for future broadcast;
upon selection of the television program listing, means for retrieving the stored video clip associated with the selected television program listing; and
means for displaying the retrieved video clip on the display screen, the retrieved video clip corresponding to the respective program that is scheduled for future broadcast.

3. The system of claim 2 further comprising means for displaying a written description corresponding to the selected television program listing.

4. The system of claim 2 further comprising means for sequencing through time slots in the television program guide.

5. The system of claim 2 wherein the means for allowing a user to select a television program listing from the television program guide comprises means for allowing the user to position an on-screen cursor on the television program listing.

6. The system of claim 2 wherein the means for allowing a user to select a television program listing from the television program guide comprises means for allowing the user to navigate an on-screen cursor between the television program listings.

7. The system of claim 2 further comprising means for identifying a first of the stored clips that is associated with the selected program listing.

8. The system of claim 2 wherein the television program listings comprise programs that are scheduled to be broadcast at a current time and programs that are scheduled to be broadcast after the current time, and wherein the selected television program listing and retrieved video clip correspond to a program that is scheduled to be broadcast after the current time.

9. The system of claim 2 further comprising means for retrieving the stored video clip associated with the selected television program listing based on the position of an on-screen cursor in relation to the selected television program listing.

10. The system of claim 2 further comprising means for positioning an on-screen cursor on the television program listings.

11. The system of claim 10, wherein the on-screen cursor visually indicates selection of a particular television program listing among the television program listings.

12. A method for displaying a video clip for a television program upon viewer selection of a corresponding television program listing from a television program guide displayed on a display screen, comprising the steps of:
storing video clips, wherein the video clips include moving images of a program that is scheduled for future broadcast;
associating the stored video clips with television program listings;
displaying the television program guide on the display screen, wherein the television program guide comprises some of the television program listings;
allowing a viewer to select one of the television program listings from the television program guide, the selected television program listing corresponding to a respective program that is scheduled for future broadcast;
upon selection of the television program listing, retrieving the stored video clip associated with the selected television program listing; and
displaying the retrieved video clip on the display screen, the retrieved video clip corresponding to the respective program that is scheduled for future broadcast.

13. The method of claim 12 further comprising the step of displaying a written description corresponding to the selected television program listing.

14. The method of claim 12 further comprising the step of sequencing through time slots in the television program guide.

15. The method of claim 12 wherein allowing a user to select a television program listing from the television program guide comprises allowing the user to position an on-screen cursor on the television program listing.

16. The method of claim 12 wherein allowing a user to select a television program listing from the television program guide comprises allowing the user to navigate an on-screen cursor between the television program listings.

17. The method of claim 12 further comprising identifying a first of the stored clips that is associated with the selected program listing.

18. The method of claim 12 wherein the television program listings comprise programs that are scheduled to be broadcast at a current time and programs that are scheduled to be broadcast after the current time, and wherein the selected television program listing and retrieved video clip correspond to a program that is scheduled to be broadcast after the current time.

19. The method of claim 12 further comprising retrieving the stored video clip associated with the selected television program listing based on the position of an on-screen cursor in relation to the selected television program listing.

20. The method of claim 12 further comprising means for positioning an on-screen cursor on the television program listing.

21. The method of claim 20, wherein the on-screen cursor visually indicates selection of a particular television program listing among the television program listings.
